(19) United States
(12) Patent Application Publication
(10) Pub. No.: US 2026/0301139 A1
(43) Pub. Date: Oct. 1, 2026

(54) IMAGE PROCESSING

(71) Applicant: Arm Limited, Cambridge (GB)

(72) Inventors: Vladimir DOLZHENKO, London (GB); Milos KOMARCEVIC, Le Cannet (FR); Dumidu Sanjaya TALAGALA, Coventry (GB)

(21) Appl. No.: 19/563,807

(22) Filed: Mar. 11, 2026

(30) Foreign Application Priority Data
Mar. 18, 2025 (GB) GB2503921.5

(51) Int. Cl. G06T 5/80; G06T 7/20; H04N 5/74

(52) U.S. Cl. CPC G06T 5/80; G06T 7/20; H04N 5/74

(57) ABSTRACT

A method comprising determining a mapping between a first image location at a first image surface, associated with a portion of an image, and a second image location at a second image surface, associated with a transformed version of the portion of the image. Determining the mapping comprises applying an analytical stereographic projection based on a geometric relationship between the first image surface and the second image surface. Image data representing the image is obtained, and comprises pixel data for a plurality of pixel locations. A portion of the pixel data for use in generating transformed pixel data for the second image location is identified, based on the first image location, and used to generate transformed pixel data for the second image location.

### CROSS-REFERENCE TO RELATED APPLICATIONS

This application claims priority to GB Application No. GB2503921.5, filed Mar. 18, 2025, under 35 U.S.C. § 119(a). The above-referenced patent application is incorporated by reference in its entirety.

### BACKGROUND

### Technical Field

The present disclosure relates to methods and systems for processing image data.

### Description of the Related Technology

Certain lenses can be used to capture images or videos with a wide field or angle of view. For example, a fisheye lens is a wide-angle lens that can be used to capture wide panoramic or hemispherical images. Lenses such as these can also be used in wearable devices for displaying visual content to a user, such as head-mounted displays (HMDs), to increase a field of view presented to the user. Such lenses typically produce a distorted image, with certain parts of the image stretched or compressed compared with other parts. This generally leads to straight image features, such as a straight lines or edges, appearing curved rather than straight.

It is known to correct the distortion in an image captured by or displayed using lenses such as these to remove or reduce curvature of straight image features.

It is desirable to provide methods and systems for processing image data, for example to adjust a geometric distortion of an image represented by the image data, which are more efficient than known methods and systems.

### BRIEF DESCRIPTION OF THE DRAWINGS

Further features will become apparent from the following description, given by way of example only, which is made with reference to the accompanying drawings in which like reference numerals are used to denote like features.

FIGS. 1A and 1B show an image captured using a fisheye lens, and a resultant image following processing of the captured image to adjust a geometric distortion respectively.

FIG. 2 is a schematic diagram illustrating a system according to an example.

FIGS. 3a and 3b show schematically examples of a stereographic projection and adjustment of a stereographic projection.

FIGS. 4a and 4b show schematically examples of stereographic projections.

FIGS. 5a and 5b show schematically further examples of stereographic projections

FIG. 6 is a schematic diagram illustrating apparatus according to an example.

FIG. 7 is a schematic diagram illustrating the relative positions of input pixel locations and input locations corresponding to output pixel locations.

FIG. 8 shows schematically an example of compensation for motion of an image capture device during capture of a frame of a video.

FIG. 9 is a schematic diagram illustrating a mapping to a cylindrical image surface.

### DETAILED DESCRIPTION

Details of systems and methods according to examples will become apparent from the following description with reference to the Figures. In this description, for the purposes of explanation, numerous specific details of certain examples are set forth. Reference in the specification to “an example” or similar language means that a feature, structure, or characteristic described in connection with the example is included in at least that one example but not necessarily in other examples. It should be further noted that certain examples are described schematically with certain features omitted and/or necessarily simplified for the ease of explanation and understanding of the concepts underlying the examples.

Examples described herein provide a method comprising determining a mapping between a first image location and a second image location. The first image location is at a first image surface associated with a portion of an image, e.g. so that the first image surface corresponds to a surface of (e.g. a plane of) the portion of the image. The first image location may correspond to a particular pixel location within the image, although in some cases the first image location may be between pixel locations of the image. The second image location is at a second image surface associated with a transformed version of the portion of the image, e.g. so that the second image surface corresponds to a surface of (e.g. a plane of) the transformed version of the portion of the image. The second image location may correspond to a pixel location within the transformed version of the portion of the image or the second image location may be between pixel locations in the transformed version of the portion of the image.

Determining the mapping comprises applying an analytical stereographic projection based on a geometric relationship between the first image surface and the second image surface. The analytical stereographic projection may be applied to the first image location to obtain the second image location or vice versa, so as to identify the mapping, which is for example a correspondence, between the first image location and the second image location. An exact solution to the mapping between the first and second image surfaces can be determined using algebra, based on the geometric relationship between the first and second image surfaces e.g. representing the spatial position of the first image surface relative to the second image surface within a particular coordinate system. Performing the stereographic projection analytically, rather than numerically, allows the stereographic projection to be calculated without interpolation, which may be more efficient. The stereographic projection for example allows an efficient parametric reprojection between the first and second image surfaces to be calculated, which may be performed in real time, e.g. to adjust geometric distortion within a frame of a video during capture or display of the frame as discussed further below.

The method in examples herein further comprises obtaining image data representing the image. The image data comprises pixel data for a plurality of pixel locations within the portion of the image. The pixel data for a given pixel location for example represents a pixel intensity value for the given pixel location, such as a pixel intensity value for at least one colour channel. Based on the first image location, a portion of the pixel data for use in generating transformed pixel data for the second image location is identified. For example, if the first image location coincides with a pixel location within the portion of the image, a portion of the pixel data representing the pixel intensity value for that pixel location may be identified as the portion of the pixel data. However, if the first image location does not coincide with a pixel location, a set of pixel locations defining in a region in the portion of the image comprising the first image location may be identified, and a portion of the pixel data for the set of pixel locations may be used as the portion of the pixel data. The image data is processed to generate transformed image data representing the transformed version of the portion of the image. Processing the image data comprises processing the portion of the pixel data to generate the transformed image data for the second image location.

In this way, the method in examples herein can be used to efficiently map coordinates within an image between image surfaces, e.g. between a coordinate system for display on a display screen and a coordinate system associated with a lens, such as a fisheye or wide-angle lens, so as to adjust the geometric distortion associated with an image. In examples herein, the mapping can be calculated on-the-fly, using an analytical approach at least for a stereographic projection of the mapping. This approach can allow geometric distortion adjustment to be performed sufficiently rapidly to be applied to video content, e.g. on a frame-by-frame basis. This may be useful where the geometric distortion of the video content evolves quickly over time, such as if the video is captured or displayed using a fisheye lens mounted to a moving article (e.g. a vehicle or a moving HMD).

In examples, applying the analytical stereographic projection generates a projected image location. In some of these examples, determining the mapping comprises adjusting the projected image location based on a lens projection parameter of a lens associated with the image data. This provides greater flexibility in the transformations that can be performed. For example, the stereographic projection can be performed and then adjusted for non-stereographic lenses so as to perform transformations other than stereographic transformations, such as gnomonic (perspective), equidistant, orthographic or equisolid transformations, and so forth. This allows the approaches herein to be used to adjust geometric distortion for images associated with (e.g. captured by or to be displayed using) stereographic lenses as well as other types of lenses. In addition, stereographic lenses may not be perfectly stereographic and may slightly differ from an ideal stereographic lens due to small deviations during manufacturing. Deviations from ideal stereographic projections can similarly be accounted for by adjusting the projected image location in this way.

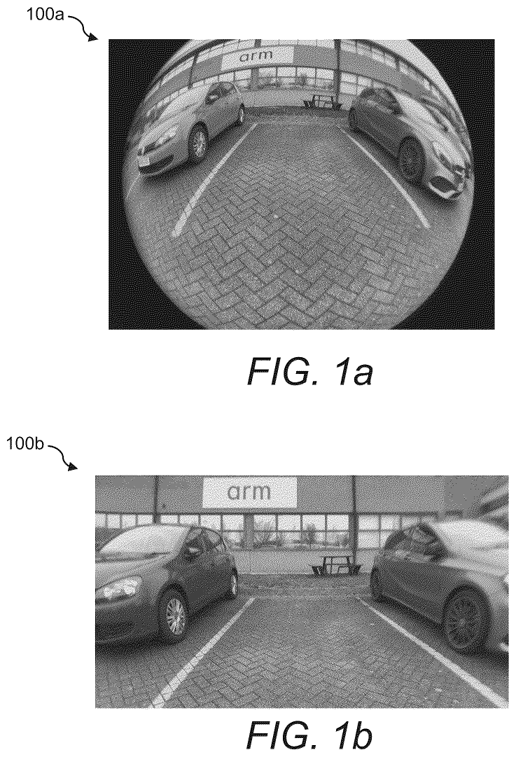

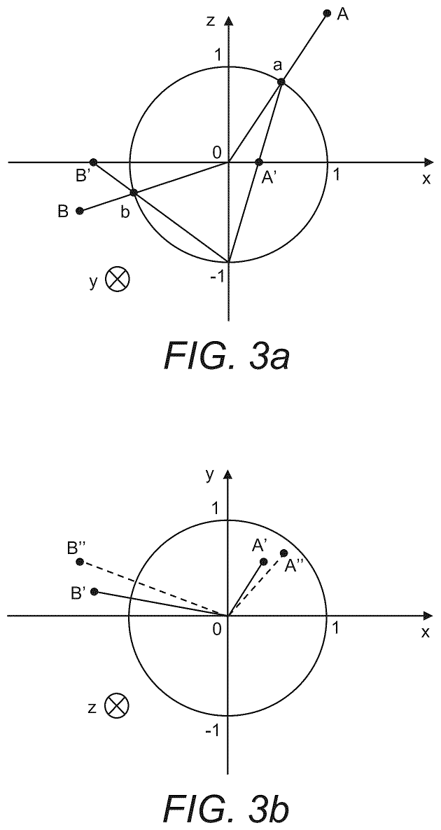

FIG. 1A shows an image 100a captured using a fisheye lens. As can be seen from FIG. 1A, the left and right edges of the image appear curved with respect to the center of the captured image 100a. FIG. 1B shows the same image after a transformation to adjust the distortion caused by the fisheye lens has been applied. The transformation comprises a stereographic projection, as discussed further below with reference to FIGS. 3 to 5. In FIG. 1B, the left and right edges of the transformed image 100b no longer appear to be curved. In the example shown in FIG. 1A, the image 100a which is captured corresponds to a central portion of the field of view of the fisheye lens. In other examples, not shown here, an image which is captured using a fisheye lens may correspond to the entire field of view of the fisheye lens.

The transformation of examples herein can be used to make a parametric reprojection between two arbitrary image spaces (e.g. between two arbitrary image planes, which may be flat or curved planes). For example, the approaches herein can be used to transform an image to a curved plane (e.g. a curved surface of a cylinder or a sphere) or vice versa.

Lenses which can capture images with a large field of view, such as fisheye lenses, may be used for a variety of applications. For example, in security applications where surveillance equipment is used to capture images and videos, fisheye lenses may be used to increase the amount of a scene or room which can be captured without the need to increase the number of cameras or use cameras which have servomechanisms. Using cameras with servomechanisms may allow a single camera to be redirected to view different parts of a room, however, it may not be possible to use such a camera to simultaneously view different regions in the room, or the entire scene. Servomechanisms also provide a further potential point of failure for the camera.

In some examples, it may be desired to process videos captured using fisheye lenses (or other lenses with a wide field of view) to adjust geometric distortion, quickly. Where video, captured using a fisheye lens, is being streamed to a display device or further processed, it may be desirable to adjust a geometric distortion of the captured images before displaying the video at the display device, or processing the image data further. Fisheye lenses are used in vehicles, such as automobiles, to provide increased field of view for drivers. Some automobiles may have rear facing cameras connected to a display device in the interior of the vehicle to allow an operator of the vehicle to see behind them. Using fisheye lenses in such applications allows the camera which is used to be small whilst providing a large field of view, without needing to rotate.

Cameras may also be used in autonomous vehicles. For example, outward facing cameras mounted on a vehicle may send video data to a computing device. The computing device may process the video data to make determinations regarding the environment in which the autonomous vehicle is operating. The computing device may also receive data from other types of sensors and may use this data, in conjunction with the determinations regarding the environment, to operate the vehicle. Using fisheye lenses (or other wide-angle lenses) may be an efficient way to capture video which represents a large field of view around the vehicle. Spatial information, extracted from the captured video, may be used to determine the position of the car in relation to objects in the environment and so the accuracy of the spatial information is important. Consequently, it may be desired to process frames of a video to adjust a geometric distortion of at least a part of a frame of the video such that spatial information which is extracted from the video may be used to operate autonomous vehicles. Due to the speeds at which vehicles may travel, it may be desirable for cameras used in the operation of autonomous vehicles to have a high frame rate such that the spatial information which is extracted from the video may be temporally accurate. Similarly, it may be desirable for frames of videos captured using fisheye lenses (or other wide-angle lenses) to be processed, to adjust a geometric distortion of at least part of a frame of the video, with a high throughput.

Fisheye (or other wide-angle) lenses may also be used in other devices comprising cameras, such as mobile computing devices like smartphone or tablet devices. In some examples, a mobile computing device comprising a camera may comprise a fisheye lens. However, in other examples a fisheye lens attachment may be attached to, and used in conjunction with, a mobile computing device having a camera with an ordinary lens. Devices comprising fisheye lenses may comprise network connectivity over a local area network (LAN) or a wide area network (WAN). In some cases, a device comprising a fisheye lens may be connected to the Internet of Things. Where a device has network connectivity, the device may be used to stream video captured using the device instantaneously over a network. Alternatively, the device may store captured video and may send the video over the network at a later time.

Lenses that introduce geometric distortion, such as fisheye or other wide-angle lenses, may be used in wearable devices for displaying images and/or video, such as HMDs, which may be used for various purposes, including augmented reality (AR), mixed reality (MR) and virtual reality (VR) applications. For example, a lens may be disposed between a display device displaying an image and a side of the wearable device configured to face a user, in use, so that light generated by the display device passes through the lens before reaching the user. The lens can be used to bend the light so as to increase the field of view as perceived by the user. However, the lens typically also geometrically distorts the image, e.g. to introduce pincushion and/or barrel distortion. It may be desirable to geometrically transform the image displayed by the display device to include an inverse of the distortion produced by the lens, so that the distortion in the image displayed by the display device is at least partially reversed by the lens. In some cases, wearable devices such as these can be used to display video content. In such cases, it may be desirable to rapidly geometrically distort frames of the video displayed by the display device to counteract the distortion introduced by the lens.

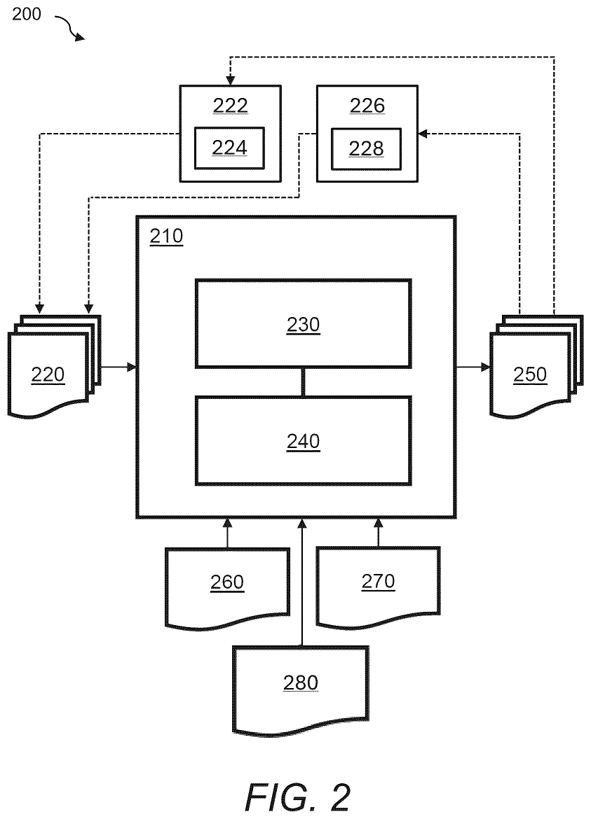

An example of internal components of a system 200 in which transformations such as those described with respect to FIGS. 1A and 1B may be applied is shown schematically in FIG. 2. The system 200 of FIG. 2 includes image processing apparatus 210. The image processing apparatus 210 may be a fixed function or system-on-chip device configured to perform the functions described herein.

The image processing apparatus 210 may be communicatively coupled to an image capture device 222, for example via an image capture device interface, which may include software and/or hardware components. In some examples, the image processing apparatus 210 and the image capture device 222 may be integrated in one device. The image capture device 222 may be any suitable device for capturing images, such as a camera or a video camera. The image may be a still image, such as a frame of a video, or a moving image, such as a video. The image capture device 222 may be arranged to capture images over a wide field, or angle, of view, for example by including a wide-angle lens. For a 35 millimeter (mm) film format, wide-angle fisheye lenses may have a typical focal length of between 8 mm and 10 mm for circular images or between 15 mm and 16 mm for full-frame images, to give an angle of view of between 100 degrees and 180 degrees or even larger than 180 degrees, for example 190 degrees.

In FIG. 2, the image capture device 222 includes a lens 224 which directs light entering the image capture device 222 towards image sensors of the image capture device 222, for detection. The projection of light by a particular lens may be parametrized by a lens projection function, for which an analytical solution may be found (referred to herein is a lens projection parameter). For example, if θ is the ray angle for a ray of light passing through the lens 224, then the distance on an image surface to which the light is to be projected (which may be referred to as a projection plane) can be found as

$$r = tan \frac{θ}{2} ,$$

where r=\sqrt{s²+t²} and s and t represent the x and y coordinates of the ray within the projection plane. If the lens equation is R=ƒ(θ), where R=\sqrt{x²+y²}, then

$$R = f ( 2 arctan r ) = r h ( {r}^{2} )$$

$$h ( {r}^{2} ) = \frac{f ( 2 arctan r )}{r}$$

where h(r²) represents the lens projection function and R represents the radial position of the ray within the projection plane (representable as a function, ƒ, of the ray angle, θ). If the derivative of ƒ(θ) at point 0 is finite, or, equivalently,

$${lim}_{θ \to + 0} \frac{f ( θ )}{θ} < ∞$$

the following lens projection functions can be determined for various types of transformation:

| Transformation | f(θ) | h(r²) |
|---|---|---|
| Stereographic | $tan \frac{θ}{2}$ | 1 |
| Gnomonic (perspective) | tan θ | $\frac{1}{1 - {r}^{2}}$ |
| Equidistant | θ | $\frac{2 arctan r}{r}$ |
| Orthographic | sin θ | $\frac{2}{1 + {r}^{2}}$ |
| Equisolid | $2 sin \frac{θ}{2}$ | $\frac{2}{\sqrt{1 + {r}^{2}}}$ |

The value of the lens projection function, h(r²), for a particular value of r² is referred to herein as the lens projection parameter, and can be used to adjust the projected image location as discussed further below with reference to FIG. 3b.

In the example of FIG. 2, the lens 224 is a non-stereographic, substantially axially-symmetric lens, which is e.g. substantially symmetric about an optical axis of the lens, radially with respect to the optical axis. A lens that is substantially symmetric is for example symmetric within manufacturing or measurement tolerances. The lens 224 may be a fisheye lens or a wide-angle lens, which projects light passing therethrough in a pattern that deviates from a stereographic pattern.

In this example, the lens projection function represents the extent to which a light ray passing through the lens 224 deviates from a position to which it would be directed with a stereographic lens. This can be seen from the table above, in which a stereographic lens has a lens projection function equal to 1, indicating that such a lens produces a pattern that does not deviate from a stereographic transformation.

In other cases, a set of lens projection parameters may be obtained via a calibration process, e.g. prior to use of the image capture device 222 to obtain the image data to be transformed. The calibration process may comprise using the image capture device 222 to capture an image of a predefined pattern (such as a rectangular grid) and then determining a set of values of the lens projection parameter for a set of r values based on an extent to which the image of predefined pattern differs from the predefined pattern itself. In such cases, the set of values of the lens projection parameter for the set of r values may be stored in a suitable data structure, such as a look-up table (LUT). The value of the lens projection parameter for particular value of r may be obtained from the data structure and then used to adjust the projected image location. In other examples, though, the value of the lens projection parameter for a particular r value may be represented directly, for example as a (fitted) higher order polynomial with a plurality of coefficients. A lens projection parameter may be used, for example, if the lens is a generally stereographic lens that produces a pattern that differs from a stereographic transformation due to manufacturing deviations in a physical structure of the lens compared to that of an ideal stereographic lens, as in such cases it may not be possible to obtain an analytical formula for the lens projection function.

The image processing apparatus 210 may instead or additionally be communicatively coupled to a display device 226, for example via a display device interface, which may include software and/or hardware components. In some examples, the image processing apparatus 210 and the display device 226 may be integrated in one device. The display device 226 may be a virtual reality (VR), augmented reality (AR) or mixed reality (MR) display device, for displaying VR, AR and/or MR content to a user. The display device 226 may be wearable, such as a head-mounted display (HMD). In FIG. 2, the display device 226 includes a lens 228, which may be similar to or the same as the lens 224 of the image capture device 222 but arranged to direct light generated by the display device 226 towards the user. The lens 228 may similarly be associated with a lens projection parameter, as described with reference to the lens 224 of the image capture device 222.

In the following description, reference will be made to the image processing apparatus 210 being “configured” to perform certain functions or operations. In cases where the image processing apparatus 210 is fixed function hardware, being “configured” may mean that the image processing apparatus 210 has been custom made to perform the functions described, or the image processing apparatus 210 may be pre-programmed to perform such functions. In other implementations, the image processing apparatus 210 may comprise one or more non-transitory computer-readable storage mediums. The one or more storage mediums may comprise computer readable instructions which, when executed by at least one processor in the image processing apparatus 210, cause the image processing apparatus 210 to perform the functions described herein. The computer-readable instructions may be in any suitable format or language, for example in machine code, an assembly language, or a hardware description language (HDL) such as Verilog or VHDL, or using high level synthesis in which an algorithmic description in a high level language such as C++ is given and can be translated to an application specific integrated circuit (ASIC) netlist.

The image processing apparatus 210 is configured to receive image data 220. The image data 220 may be received from the image capture device 222 or the display device 226. The image data 220 may represent an input frame of a video or a still image (or a portion thereof). The image data 220 may comprise pixel data for a plurality of pixel locations in a portion of an image to be transformed. The first image surface for example corresponds to a surface associated with the image data 220, such as a plane in which the pixel locations are arranged. The pixel data may comprise, for each pixel location, pixel intensity values corresponding to different colour channels. The colour channels may correspond to red, green, and blue colour channels. Other colour channels may include a channel representing an intensity or brightness of the corresponding pixel locations.

The image processing apparatus 210 includes storage 230. The storage 230 of the image processing apparatus 210 in the example of FIG. 2 is used to store image data representing an image, such as an input frame of a video. The storage 230 may also store other data in addition. The temporary storage 230 may include at least one of volatile memory such as Random-Access Memory (RAM), for example Static RAM (SRAM) or Dynamic RAM (DRAM), and non-volatile memory, such as Read Only Memory (ROM) or a solid-state drive (SSD) such as flash memory. The storage 230 may be temporary storage with a fixed capacity and, as data is being stored in the storage 230, data which was previously stored in the storage 230 may be removed from the storage 230 to make space for the data which currently being stored.

The image processing apparatus comprises at least one processor 240. The at least one processor 240 in the example of FIG. 2 may include a microprocessor, a general-purpose processor, a digital signal processor (DSP), an ASIC, a field programmable gate array (FPGA) or other programmable logic device, a discrete gate or transistor logic, discrete hardware components, or any suitable combination thereof designed to perform the functions described herein. The processor 240 may be or include a graphics processing unit (GPU). A processor may also be implemented as a combination of computing devices, e.g., a combination of a DSP and a microprocessor, a plurality of microprocessors, one or more microprocessors in conjunction with a DSP core, or any other such configuration.

The image processing apparatus 210 may be configured to process the image data 220, e.g. representing an input frame of a video or a still image or portion thereof, to generate transformed image data 250, e.g. representing an output frame or transformed image or portion thereof. In examples in which the storage 230 is temporary storage, the image processing apparatus 210 may be configured to stream the image data 220, representing an input frame of a video, into the storage 230. Once the storage 230 becomes full, the storage 230 may overwrite previously stored image data 220 according to a first in first out (FIFO) protocol. For example, image data 220 may be streamed into the storage 230 in parts, for example as blocks of data, wherein each block represents a horizontal portion of the input frame (e.g. a row or set of rows of pixels of the input frame).

In some cases, the image (e.g. the input frame) may comprise a plurality of horizontal portions, such as several hundred horizontal portions. Each portion may have a height corresponding to one pixel, or in some cases each portion may have a height corresponding to more than one pixel in the image. The image data 220 may be larger than the capacity of the temporary storage. For instance, image data 220 representing an input frame may be 1 megabyte whereas the storage 230 may have a capacity in the order of kilobytes and so may not be able to store all of the image data 220 representing the input frame at once. In some examples, the storage 230 may be able to store less than a hundred parts of the image data 220. Consequently, once the storage 230 is full, subsequent parts of the image data 220, representing respective portions in the image, may be stored in the storage 230 by removing an oldest part of input image data which was previously stored in the temporary storage 230.

Streaming the image data 220 into the storage 230 in this way may prevent all of the image data 220 from being accessible at the same time to be processed by the image processing apparatus 210. However, storing the image data 220 in this way may reduce the amount of memory which is required in the image processing apparatus 210. Further, processing portions of the image data in an ordered manner when instructed may reduce the computing power which would otherwise be spent performing more complex memory access procedures. However, due to the geometric distortion of an image captured using an image capture device having a lens with a wide field of view, the order in which portions of transformed image data 250 are produced may differ to the order in which portions of image data 220 are streamed into the memory 230. Consequently, the image processing apparatus 210 uses ordering data 260 to determine the order in which portions of transformed image data 250 are to be generated.

The image processing apparatus 210 may be configured to obtain ordering data 260 indicating a variable order in which portions of transformed image data 250 are to be generated. The ordering data 260 may be based on at least one characteristic of the image data 220. Portions of the transformed image data 250 represent respective pixel locations in the transformed version of the portion of image. In some examples, portions of the transformed image data 250 may be stored as a plurality of tiles. Each tile may comprise a plurality of portions of the transformed image data 250 representing a respective plurality of pixel locations (referred to herein as second image locations, associated with the transformed version of the portion of the image at a second image surface, e.g. in the output frame). In some examples, the ordering data may indicate an order in which tiles of the plurality of tiles are to be generated.

The image processing apparatus 210 is configured to obtain lens projection data 270 associated with the image capture device 222 and/or the display device 226. The lens projection data 270 is usable for obtaining at least one value of a lens projection parameter of the lens 224 of the image capture device 222 (if the image data is captured by the image capture device 222) or of the lens 228 of the display device 226 (if the image data is for use in displaying content using the display device 226). The lens projection data 270 is usable in adjusting a projected image location obtained by an analytical stereographic projection in order to apply a desired transformation to the image represented by the image data.

Obtaining lens projection data 270 may comprise receiving the lens projection data 270, for example, from a computing device communicatively coupled to the apparatus. As explained above, the lens projection data 270 may be determined using a calibration process of the image capture device 222 and/or display device 226, which may be performed using suitable data processing apparatus such as the computing device, a further computing device or the image processing apparatus 210 or system 200 itself, and then stored in storage of the computing device. In some examples, the lens projection data 270 may be obtained from a device comprising the system 200 such as a smartphone or other computing device comprising the apparatus and further hardware, for example at least one processor and at least one memory.

The lens projection data 270 may indicate or otherwise represent the particular transformation that is to be applied to the image data, e.g. to adjust a geometric distortion of the portion of the image represented by the image data. For example, the transformation may include at least one of a panoramic transformation, a stereographic projection, an equidistant projection, an equisolid projection. However, each of these transformations may be performed by analytically performing a stereographic projection and then adjusting the stereographic projection (for transformations other than stereographic projections). For example, the lens projection data 270 may represent the lens projection function or at least one value of the lens projection parameter itself for a particular transformation. In other cases, though, the lens projection data 270 may indicate the type of transformation that is to be performed, which may be used to obtain a lens projection function and/or a lens projection parameter for that particular transformation, e.g. from storage internal or external to the image processing apparatus 210.

The image processing apparatus 210 may also obtain transformation data 280 indicative of at least one characteristic of the transformation, e.g. for further configuring the transformation to be performed. The transformation data for example indicates the geometric relationship between the first and second image surfaces. For example, the first image surface may be at a predefined location in a given coordinate system, in which case the transformation data 280 may represent the location of the second image surface in the given coordinate surface (or vice versa), or the transformation data 280 may indicate a position of the first and second image surfaces relative to each other. In general, the first and second surfaces may each be defined by intrinsic parameters (such as field of view, lens or projection type, pixel resolution etc.) and extrinsic parameters (such as the relative displacement and/or rotation between their respective coordinate systems and/or basis vectors). The geometric relationship between the first and second surfaces may accordingly be defined by or based on these intrinsic and extrinsic parameters. For example, the transformation data 280 may include a set of basis vectors (e.g. a set of 3-dimensional orthonormal basis vectors) in the first and/or second image surfaces, within a predefined coordinate system, so as to indicate the image surfaces between which the mapping is to be performed. In other cases, though, the set of basis vectors of the first and/or second image surfaces may be predefined and may e.g. be stored in the storage 230 of the image processing apparatus 220. The geometric relationship between the first and second image surfaces may instead or additionally be indicated by the lens projection data 280, in which case the transformation data 280 may be omitted. Alternatively, the transformation data 280 may itself allow value(s) of the lens projection parameter to be determined, in which case the lens projection data 270 may be omitted.

FIGS. 3a and 3b show schematically examples of a stereographic projection that can be performed analytically in a 3D Cartesian (x, y, z) coordinate system. FIG. 3a shows the xz plane and FIG. 3b shows the xy plane. In FIGS. 3a and 3b, points A and B in a 3D space are projected onto the xy plane to obtain points A′ and B′, and then points A′ and B′ are adjusted in the xy plane to obtain points A″ and B″. Points A and B are examples of second image locations at two different second image surfaces. The z axis corresponds to an optical axis of a lens of a system associated with an image to be transformed via the stereographic projection shown (such as the lens 224 of the image capture device 222 or the lens 228 of the display device 226 of FIG. 2). The xy plane corresponds to a plane of the lens (e.g. corresponding to an image as obtained by or to be displayed using the lens, such as a fisheye image), and in FIGS. 3a and 3b is a flat plane.

Point A is projected onto the xy plane (which is an example of a first image surface) by first projecting point A onto the unit sphere to obtain the point a. The point a is then projected from the unit sphere through the point (0, 0, −1) to the xy plane, to obtain the point A′, which is an example of a first image location at the first image surface. Point B is similarly projected onto the unit sphere to obtain the point b, which is then projected through the point (0, 0, −1) to the xy plane, to obtain the point B′. These are examples of stereographic projections, which are conformal (so as to retain an angle of a given point with respect to the origin) and allow mapping over a field of view of over 180 degrees without encountering singularities. As can be seen, points that are in the lower hemisphere in the xz plane of FIG. 3a, such as point B, and which are outside of the 180 degree field of view represented by the upper hemisphere in the xz plane of FIG. 3a, are mapped by this stereographic projection to points outside the unit sphere. In contrast, points that are within the 180 degree field of view represented by the upper hemisphere in the xz plane of FIG. 3a, are mapped by this stereographic projection to points within the unit sphere. The points A and B for example correspond to pixel locations at respective second image surfaces.

FIG. 3b shows the stereographic projection of points A, B onto the xy plane to obtain projected points A′, B′, which are examples of projected image locations (in this case, at the first image surface). In this case, the stereographic projection is along the optical axis of the lens, and the optical axis is substantially perpendicular to the xy plane, such as perpendicular within manufacturing or measurement tolerances. The projected points A′, B′ represent an ideal stereographic projection of the points A, B onto the xy plane. However, for an arbitrary lens (which is for example non-stereographic but axially-symmetric), it can be assumed that there is a mapping of the ray angle, defined as an angle between an image ray and the z axis, and the distance from the origin within the xy plane (e.g. corresponding to the centre of the image). This ray angle can be converted to a distance from the origin within the xy plane (which in this case corresponds to a stereographic projection plane). If the coordinates of a point, such as point A′, within the xy plane are represented as (s, t), then the (x, y) coordinates of a point on the image in the xy plane, after accounting for the deviation of the lens from an ideal stereographic lens, can be calculated as:

$$x = s \cdot h ( {s}^{2} + {t}^{2} )$$

$$y = t \cdot h ( {s}^{2} + {t}^{2} )$$

where h(s²+t²) represents a value of a lens projection parameter (e.g. as described with reference to FIG. 2) at a particular value of (s²+t²). The value of the lens projection parameter may be obtained analytically from a lens projection function or may be retrieved from a suitable data structure. In FIGS. 3a and 3b, h(s²+t²) represents a superposition of a lens angle function and a stereographic projection to angle transformation.

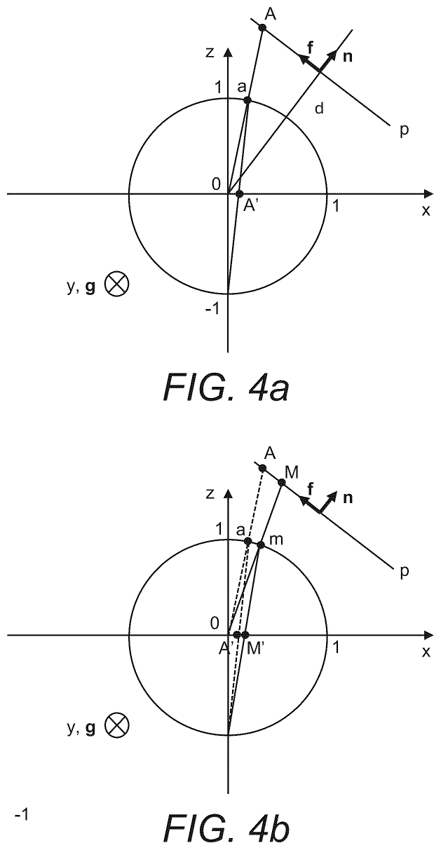

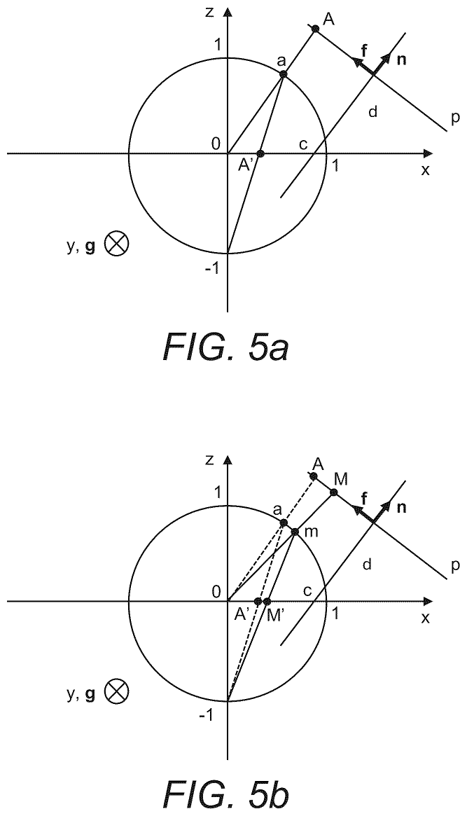

The calculation of (x, y) from (s, t) amounts to adjustment of the stereographic projection (i.e. points A′, B′) based on the lens projection parameter, so as to obtain a mapping from points at the second image surface (A, B) to points at the first image surface (i.e. points A″, B″). The points A″, B″ are examples of first image locations to which respective second image locations are mapped. The points A″, B″ may correspond to respective pixel locations in their respective first image surfaces, but need not. The adjustment of the stereographic projection in this example is within the first image surface itself. It is to be appreciated, that in this example, points A and B are examples of points in two different second image surfaces. In other examples, though, a plurality of points from the same second image surface may be mapped to the first image surface, as described further with reference to FIGS. 4 and 5. Furthermore, in some cases (e.g. for ideal stereographic lenses), h(s²+t²)=1 for all values of s and t, in which case A′=A″, and B′=B″, so that, after processing the projected image location with lens projection data representing the lens projection parameter does, the projected image location is unchanged.

FIG. 4 shows schematically examples of a mapping from an arbitrary plane (which is given as an example of the second image surface) to a first image surface, using the stereographic projection shown in FIG. 3, which is performed analytically based on the geometric relationship between the first and second image surfaces. FIG. 4 uses the same coordinate system as in FIG. 3 and shows the mapping in the xz plane.

In FIG. 4a, a point A at the second image surface (which may be referred to as a second image location) is mapped to point a on the unit sphere and then through the point (0, 0, −1) to a point A′ at the first image surface, which corresponds to the xy plane. The first image surface in this case corresponds to the surface of the image which is to be transformed (e.g a fisheye image, as captured using a fisheye lens) and the second image surface corresponds to the surface to which the image is to be transformed (in this example corresponding to a viewing plane, p, such as a plane of a display screen for displaying the transformed image). An orthonormal set of basis vectors within the viewing plane, p, is represented as (f, g, n), where n is a normal to the plane p and f, g are two-dimensional (2D) on-screen coordinates representing a 2D position of a given image location on screen, at the second image surface (e.g. corresponding to a pixel position of the given image location within a 2D array of pixels corresponding to the pixel layout of the screen). This orthonormal set of basis vectors defining the second image surface defines the geometric relationship between the first and second image surfaces, assuming that the first image surface is defined as being the xy plane, at z=0, centred on the origin within the coordinate system in which this orthonormal set of basis vectors is defined.

The point A at the second image surface has coordinates:

$$\vec{A} = u \vec{f} + v \vec{g} + l \vec{n}$$

Point \vec{α}=α₁\vec{X}+α₂\vec{Y}+α₃\vec{Z} on the unit sphere has coordinates:

$$\vec{a} = \frac{\vec{A}}{‖ \vec{A} ‖}$$

The projection of the point A on the plane xy is:

$$\{ \begin{matrix}\vec{A} = - \vec{Z} + β ( \vec{a} + \vec{Z} ) \\ \vec{{A}^{′}} \cdot \vec{Z} = 0\end{matrix}$$

from which it can be calculated that:

$$\{ \begin{matrix}β = \frac{1}{{a}_{3} + 1} \\ s = {A}_{1}^{′} = β {a}_{1} = \frac{{a}_{1}}{{a}_{3} + 1} \\ t = {A}_{2}^{′} = β {a}_{2} = \frac{{a}_{2}}{{a}_{3} + 1}\end{matrix}$$

Noting that \vec{A}=\vec{α}·∥\vec{A}∥, the stereographic projection to the xy plane (the first image surface) can be calculated as A′=(s, t), where s and t are:

$$\{ \begin{matrix}s = \frac{{A}_{1}}{{A}_{3} + ‖ \vec{A} ‖} \\ t = \frac{{A}_{2}}{{A}_{3} + ‖ \vec{A} ‖} \\ ‖ \vec{A} ‖ = \sqrt{{A}_{1}^{2} + {A}_{2}^{2} + {A}_{3}^{2}}\end{matrix}$$

As explained with reference to FIGS. 3a and 3b, the stereographic projection to the xy plane (represented in 2D by the coordinates (s, t) and corresponding to a projected image location, A′) can then be further adjusted within the xy plane (the first image surface), based on the lens projection parameter, to obtain the first image location (A″, shown in FIG. 3b) at the first image surface that corresponds to the second image location, A, at the second image surface. In this way, a mapping between the first image location and the second image location can be determined.

The mapping can be used to adjust geometric distortion within a portion of an image. For example, a first geometric distortion of the image may differ from a second geometric distortion of the transformed version of the image. Due to the differing geometric distortion, the position of the first image location relative to the centre of the image may differ from the position of the second image location relative to the centre of the transformed image, as shown and described further with reference to FIGS. 1a and 1b.

The example mappings described herein may be performed between a plurality of first image locations at the first image surface and a corresponding plurality of second image locations at the second image surface, in order to obtain a plurality of mappings between the first and second image surfaces, which can then be used to transform an image between the first and second image surfaces. For example, FIG. 4a may be considered to illustrate a stereographic projection for use in obtaining a first mapping between the point A at the second image surface and a corresponding point at the first image surface. FIG. 4b shows schematically the same stereographic projection as for FIG. 4a, but to project a point M at the second image surface to a point M′ at the first image surface. The line from the centre of the first image surface to the centre of the second image surface, denoted din FIG. 4a, is omitted in FIG. 4b for clarity. The point M corresponds to a different image location at the second image surface than the point A. The stereographic projection of FIG. 4b (corresponding to point M′) can then be adjusted based on a lens projection parameter, e.g. as described with reference to FIG. 3b, to obtain a mapping between the point M at the second image surface and a corresponding point at the first image surface, which may be considered to be a further mapping. The corresponding point at the first image surface (e.g. which may be similar to point A″ shown in FIG. 3b, but obtained by adjusting point M′ at the first image surface, and is referred to herein as M″) is an example of a third image location at the first image surface, and the point M is an example of a fourth image location at the second image surface. It is to be appreciated, though, that in examples in which the transformation is a stereographic projection itself, adjustment of the point M′ at the first image surface may be omitted, in which case the point M′ is an example of a third image location corresponding to the fourth image location and the mapping between M and M′ is an example of a second mapping.

The stereographic projection of the point M may be performed in the same manner as that for the point A, described with reference to FIG. 4a. This approach comprises 6 multiplication operations and 6 addition operations to calculate the location of point M in space. For example, if the point M at the second image surface has coordinates:

$$\vec{M} = {u}^{′} \vec{f} + {v}^{′} \vec{g} + {l}^{′} \vec{n}$$

then calculating \vec{M} involves 3 multiplications of the scalar coordinate u′ with the 3 components of the vector \vec{f} and 3 multiplications of the scalar coordinate v′ with the 3 components of the vector \vec{g}. The l′\vec{n} component of \vec{M} can be treated as a constant, e.g. corresponding to an initial value of \vec{M}, and thus utilises minimal hardware resources compared to calculating values on a per-pixel basis. Then, to calculate \vec{M} comprises adding each of the 3 components of \vec{M}, involving a first addition of corresponding components of u′\vec{f} to the initial value of l′\vec{n} and a second addition of corresponding components of v′\vec{g} to the sum of u′\vec{f} and l′\vec{n}. This amounts to a total of 6 multiplication and 6 addition operations in this example. A count of operations for other projections or transformations described herein may be performed similarly.

After calculating the location of point M in space, there are then 3 multiplication operations, 2 addition operations, and a square root operation to calculate the modulus of M, then 1 addition and 2 division operations to calculate M′, then 4 multiplication operations, 1 addition operation and (in this example) a LUT operation to obtain the value of the lens projection parameter for a particular value of (s²+t²) to obtain M″. This amounts to a total of 13 multiplication operations, 10 addition operations, 2 division operations, 1 square root operation and at least 1 LUT operation.

In examples, though, the computational complexity (and the number of computational operations) for calculating a mapping between M and M″ is reduced by using difference data, indicating a difference between A and M (if the mapping is from A to A″ and M to M″) or between A″ and M″ if mapping is from A″ to A and M″ to M. In other words, the difference data is indicative of a difference between the first image location and the third image location, at the first image surface, or a difference between the second image location and the fourth image location, at the second image surface. If the mapping is to be performed from the first image surface to the second image surface, the difference may be between first and third image locations corresponding to respective pixel locations along the same row as each other at the first image surface (e.g. neighbouring pixel locations within a given row at the first image surface). Conversely, if the mapping is from the second image surface to the first image surface, the difference may be between second and fourth image locations corresponding to respective pixel locations along the same row as each other at the second image surface (e.g. neighbouring pixel locations within a given row at the second image surface).

In FIG. 4b, M is a horizontally displaced sampling point with respect to A in the second image surface (where the distance between A and M is exaggerated for clarity and the stereographic projection for A is shown with dotted lines for comparison to the stereographic projection for M). In this case, A and M are each respective pixel locations within the same row of a plurality of rows at the second image surface. For example, A and M may be neighbouring, e.g. adjacent, pixel locations within the same row of an array of horizontal rows and vertical columns of pixel locations (corresponding to neighbouring pixels within the same row in this example). Calculating a difference between pixel locations within the same row may be more straightforward than other differences, which in turn can allow the mapping of M to be determined more efficiently (based on this difference).

For the orthonormal basis (f, g, n), the modulus of the vector A is ∥\vec{A}∥=\sqrt{u²+v²+l²}. The difference between adjacent pixel locations at the second image surface (e.g. corresponding to an output frame to be transformed from an input frame corresponding to the first image surface) can be expressed as: Δ\vec{A}=\vec{f}Δu. The stereographic projection of M can be calculated using this difference between A and M. This reduces the complexity of calculating M to 3 addition operations, and reduces the complexity of calculating ∥\vec{M}∥ to 2 addition operations and 1 square root operation (using accumulators to calculate u²). This amounts to a total number of operations to calculate the mapping of M to M″ of 4 multiplications, 7 addition operations, 2 division operations, 1 square root operation and 1 LUT operation. This is a reduction of 9 multiplication operations and 3 addition operations compared to calculating the mapping of M to M″ directly, rather than based on a difference between M and A. In this way, mappings can be performed more rapidly, with lower resource consumption.

The calculation of the mappings described herein are typically non-singular, which can allow fixed-point arithmetic to be used to calculate mappings according to examples herein. This approach may be less computationally intensive than use of floating-point arithmetic. A division operation can be replaced with 1 reciprocal and 2 multiplication operations. A square root operation can either be calculated directly or using CORDIC (coordinate rotation digital computer) in vectoring mode (to find a magnitude of a vector with components u and =\sqrt{v²+l²}).

For further computational efficiency, a LUT from which the lens projection parameter is obtained can be implemented using a piecewise-linear or higher order interpolation, 1 to 3 multiplication operations and a similar number of add and shift operations. For example, instead of calculating some high order polynomial function y=ƒ(x), a curve can be approximated and represented by a (limited) number of e.g. linear (or quadratic/cubic) sections defined by their nodes x1, x2, . . . xN and y1, y2, . . . yN. In the linear case, the y for any arbitrary x is then y=yJ+(x−xJ)*(yK−yJ)/(xK=J) where xJ, xK are nodes surrounding x. (The node distance of xK−xJ can be fixed and chosen so the division operation can be implemented efficiently, e.g. using multiply and shift.)

FIG. 5 shows schematically further examples of mappings between image locations in the first and second image surfaces. In FIG. 4, the first image surface has a first normal (along the z axis) at a first origin of the first image surface, and the second image surface has a second normal (in the direction of the vector n) at a second origin of the second image surface. It is to be appreciated that the terms “first” and “second” in this context are merely to indicate whether a particular feature is associated with the first or second image surface. In other words, reference to a “first” normal etc. at a particular image surface does not necessarily imply that there is a “second” normal etc. at that image surface (and vice versa).

The line d from the second origin to the first origin, in a direction parallel to the second normal, intersects the first origin in FIG. 4. However, in FIG. 5, in which the mapping is applied to the second image location to obtain the first image location corresponding to the second image location, the line d intersects the first image surface at a position c that is displaced from the first origin. In other examples, in which the mapping is applied to the first image location, the first normal may intersect the second image surface at a position displaced from the second origin. In either of these examples, the stereographic projection may use displacement data indicative of a displacement of this position from the first or second origin. The position or displacement may be referred to as a first or second position or displacement for positions or displacements in the first or second image surfaces, respectively. Similarly, the displacement data may be referred to as first or second displacement data when referring to displacement data representing a first or second displacement in the first or second image surface, respectively.

In FIG. 5a, the displacement data represents a displacement, \vec{D}, which may be considered a translational displacement relative to the origin of the first image surface, which can be expressed as: \vec{D}=D₁\vec{X}+D₂\vec{Y}+D₂\vec{Z}. The expression for \vec{A} can thus be updated to: \vec{A}=u\vec{f}+v\vec{g}+l\vec{n}+\vec{D}. The initial calculation of \vec{A} then involves 3 more addition operations, while the calculation of \vec{M} based on a difference between \vec{M} and \vec{A} remains unchanged. The calculation of the modulus of \vec{A} however becomes more complex if plane coordinates are used:

$$‖ \vec{A} ‖ = \sqrt{{u}^{2} + {v}^{2} + {l}^{2} + {D}_{1}^{2} + {D}_{2}^{2} + {D}_{3}^{2} + 2 ( \vec{D} \cdot \vec{f} ) u + 2 ( \vec{D} \cdot \vec{g} ) v + 2 ( \vec{D} \cdot \vec{n} ) l}$$

However, the initial calculation can still be done with the same budget of 3 multiplication and 2 addition operations directly as

$$‖ \vec{A} ‖ = \sqrt{{A}_{1}^{2} + {A}_{2}^{2} + {A}_{3}^{2}}$$

instead, while the calculation of the modulus of \vec{M} based on \vec{A}, e.g. along the same row of image locations, involves one extra addition operation compared to the case with no translation above (noting that the projection of \vec{D} to \vec{f} is constant within the image, for example, and can be pre-calculated, and that ∥\vec{A}∥² can be accumulated rather than u²:

$$‖ \vec{M} ‖ = \sqrt{{‖ \vec{A} ‖}^{2} + 2 u Δ u + Δ {u}^{2} + 2 ( \vec{D} \cdot \vec{f} ) Δ u}$$

The total number of operations for the general case including translation for example amounts to 4 multiplication, 8 addition, 2 division, 1 square root and 1 LUT operation to calculate a transformed image location (e.g. corresponding to coordinates (x, y) within the first image surface, as shown in FIG. 3b), for image locations for which the mapping is performed based on a mapping of an other image location (e.g. within the same row), with an extra 9 multiplication and 6 addition operations for mappings performed without the use of displacement data, such as the first image location at the start of each row. In cases in which the displacement data is not used to calculate a stereographic projection, the stereographic projection (e.g. from point A to point A′), and then the adjustment of the stereographic projection in the first image surface (in this case, to obtain the point A″ from point A′, which is not shown in FIG. 5a, but is obtained similarly to point A″ in FIG. 3b) can be calculated as described with reference to FIG. 4a.

Given an image at the first image surface (e.g. corresponding to a fisheye image obtained with a fisheye lens having an optical axis corresponding to the z axis of FIG. 4), the mapping between the first and second image locations can be used to obtain a transformed version of the image at the second image surface. In this example, image data representing the image comprises pixel data for a plurality of pixel locations within the portion of the image, as discussed above, such as pixel intensity values for respective pixels of the image. In examples herein, a portion of the pixel data for use in generating transformed pixel data for the second image location is identified based on the first image location and processing the image data to generate transformed image data representing the transformed version of the portion of the image comprises processing the portion of the pixel data. This approach may be performed for a plurality of first image locations at the first image surface, e.g. to identify a respective portion of the pixel data and use the identified portion of the pixel data to generate respective transformed pixel data. For example, in examples in which a further mapping between a third image location at the first image surface and a fourth image location at the second image surface is determined, the method may comprise identifying, based on the third image location, a further portion of the pixel data for use in generating further transformed pixel data, and the processing the image data may comprise processing the further portion of the pixel data to generate the further transformed pixel data for the fourth image location.

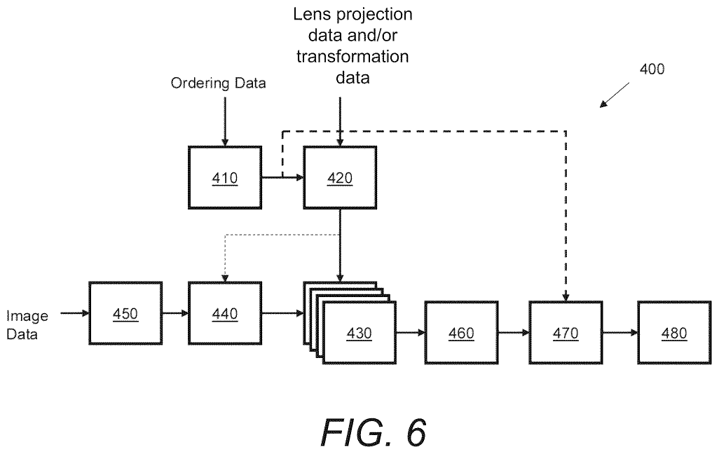

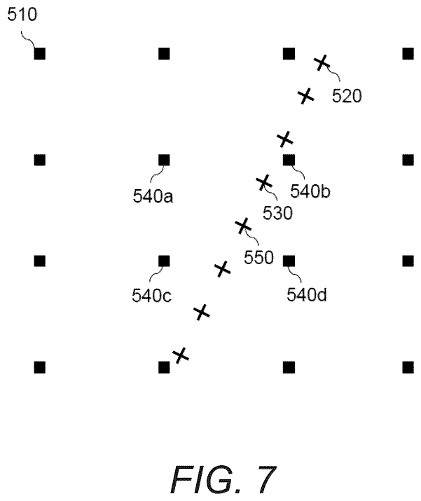

In some cases, the first image location corresponding to a given second image location coincides with a pixel location within the portion of the image. In these cases, transforming the image may involve simply taking the pixel intensity value(s) for that pixel location and using those value(s) for the second image location corresponding to that pixel location (which coincides with the first image location at the first image surface). In other cases, though, the first image location for a given second image location does not coincide with a pixel location within the portion of the image. In these cases, an interpolation process may be used to determine pixel intensity value(s) for the second image location. In such cases, the interpolation process may involve interpolating pixel intensity value(s) for a set of pixel locations (e.g. represented by a portion of the pixel data) defining a region comprising the first image location, such as the n nearest neighbouring pixel locations to the first image location, as will be discussed now with reference to FIGS. 6 and 7.

FIG. 6 shows schematically an apparatus 400 according to an example. The apparatus comprises an ordering system 410 for obtaining ordering data. The ordering data may indicate an order in which portions of transformed image data are to be generated. The ordering data may comprise coordinates associated with transformed image locations in the portion of the transformed image represented by the transformed image data, e.g. an output frame. For example, the coordinates may correspond to pixel locations in the transformed version of the portion of the image. Alternatively, the ordering data may comprise an indication of an order, and the ordering system 410 may be used to determine the coordinates of the transformed image locations in order. The ordering system 410 then forwards the coordinates to a transformation system 420 of the apparatus 400 in an order which is indicative of the order in which the transformed image is to be generated.

The transformation system 420 is communicatively coupled to the ordering system 410. In this example, the transformation system 420 obtains lens projection data for use in obtaining a value of a lens projection parameter for adjusting a stereographic projection, as described with reference to FIG. 2. In other examples in which the stereographic projection is not adjusted, the transformation system 420 need obtain lens projection data. The transformation system 420 may also obtain transformation data indicative of at least one characteristic of the transformation, as discussed further with reference to FIG. 2. The transformation system 420 performs the transformation, e.g. as described with reference to FIGS. 2 to 5 (and which may use the lens projection data and/or the transformation data), to determine a mapping between a first image location, associated with a portion of an image at a first image surface, and a second image location, associated with a transformed version of the portion of the image at a second image surface. In FIG. 6, the transformation system 420 obtains the coordinates of transformed image locations of the transformed version of the portion of the image (which are examples of second image locations at the second image surface) from the ordering system 410 in an appropriate order. The transformation system 420 then maps these second image locations (which may use the lens projection data and/or transformation data) to corresponding first image locations of the image. In this way, the transformation system 420 identifies a portion of the image to be processed to obtain a particular, corresponding portion of the transformed version of the image. The transformation system 420 may generate requests, in the form of coordinate requests, or tile coordinate requests, indicating an order in which portions of image data are to be processed.

A pixel interpolation system 430 is communicatively coupled to the transformation system 420 and is used to process the identified portions of image data. In some examples, the pixel interpolation system 430 may comprise a plurality of interpolation systems operating on different colour channels, for example, four. Each pixel interpolation system may receive either full resolution or a down-sampled resolution of image data. Methods of processing image data in the pixel interpolation system 430 will be described later with reference to FIG. 7.

The output from the transformation system 420 may also be sent to storage 440, which may be temporary storage. The storage 440 has a streaming input for streaming the image data. The storage 440 is also communicatively coupled to the pixel interpolation system 430 to provide the image data to be processed. The output from the storage 440 to the pixel interpolation system 430 may be provided in an order corresponding to requests from the transformation system 420. The image data may be provided to the pixel interpolation system 430 in blocks. For example, the storage 440 may provide image data comprising pixel data for a plurality of pixel locations within the portion of the image to the pixel interpolation system 430, for use in generating transformed pixel data for the transformed version of the portion of the image.

The pixel locations may comprise a 4×4 grid of pixel locations in the image, which may be an input frame, such as a 4×4 grid of pixel locations defining a region at the first image surface comprising the first image location. The storage 440 may also comprise or be communicatively coupled to a module which monitors the image data stored in the storage 440 so that requests from the transformation system 420 can be processed correctly, and the relevant image data forwarded to the pixel interpolation system 430.

The apparatus 400 also comprises a pre-processing system 450. The pre-processing system 450 may be used to convert the image data into a linear domain from a tone mapping domain. The pre-processing system 450 may implement a look-up table such as a linearization look-up table. Processing linear data may result in higher quality output data and may be simpler to process. The pre-processing system 450 may enable the apparatus 400 to process both linear and non-linear color spaces. The pre-processing system 450 may also support the use of floating-point storage such as single-precision floating-point format or half-precision floating points (FP16).

The apparatus 400 comprises an output formatter 460. The output formatter 460 may perform the inverse operation of the pre-processing system 450 such that the image data which is output from the apparatus 400 may be in the same format as the image data input to the apparatus 400. The output formatter 460 may also implement other functions. For example, the output formatter 460 may perform gamma compression and/or may perform recombination of the separate colour channels, such that the transformed image data is in an appropriate format to be stored for later use or for further processing. The output formatter 460 may also produce output image data which is in a different format and/or represents a different colourspace to the image data input to the apparatus 400 and/or the image data stored in the storage 440.

The apparatus 400 may comprise a tile cache 470. Portions of transformed image data, e.g. representing an output frame, may be stored in tiles. As portions of transformed image data are generated they may be stored in the tile cache 470. Once a full tile has been generated and stored in the tile cache 470, the transformed image data representing the tile may be output from the apparatus 400 and may be stored and/or further processed. The tile cache 470 may also be referred to as a tile first in first out (FIFO) module. The tile cache 470 may also receive coordinate data (e.g. representing second image locations, e.g. corresponding to pixel locations, at the second image surface) from the ordering system 410. For example, where the ordering system 410 generates one or more coordinates corresponding to a tile which is to be output, the one or more coordinates may be sent to the tile cache 470. Once the transformed image data representing that tile has been received at the tile cache 470, the tile cache may forward the transformed image data corresponding to the tile with the relevant coordinate which identifies that tile to be stored or further processed. In this way the apparatus 400 may store or forward transformed image data in tiles which are associated with an indication of their relative position in the transformed version of the image. In the example shown in FIG. 6, the apparatus 400 comprises a direct memory access writer 480 for writing the transformed image data, e.g. representing a tile, to storage.

FIG. 7 shows schematically input pixel locations representing a portion of an image to be transformed, e.g. an input frame. The input pixel locations are at the first image surface and may be referred to interchangeably as first pixel locations. The input pixel locations are shown as squares in FIG. 7. For example, square 510 represents an input pixel location which is represented by a portion of pixel data of the image data, the portion of pixel data representing at least one pixel value. FIG. 7 also shows a plurality of first image locations, represented as crosses, such as cross 520, which correspond to output pixel locations in a transformed version of the portion of the image, e.g. an output frame. The output pixel locations may be referred to interchangeably as second pixel locations, and in this example correspond to respective second image locations. In FIG. 7, the first image locations are at the first image surface, the second image locations are at the second image surface, and the first and second image surfaces are overlaid with each other for ease of illustration (although, typically, the first and second image surfaces are not coincident with each other). First image locations corresponding to particular second image locations are determined using the mappings described herein, comprising analytical stereographic projection and, in some cases, adjustment of the stereographic projection based on a lens projection parameter, e.g. using the transformation system 420 of FIG. 6. As can be seen in FIG. 7, there may not be an input pixel location for each first image location. In some instances, the input pixel locations shown using squares and the first image locations which correspond to second image locations (in this case, to output pixel locations) shown using crosses will overlap. However, this is not usually the case, and is not the case in FIG. 7.

Consequently, the image data representing the portion of the image may be processed, for example, using interpolation, to generate the transformed image data representing the transformed version of the portion of the image. In an example, the image data comprises pixel data for a plurality of pixel locations within the portion of the image and a portion of the pixel data for use in generating transformed pixel data for a particular second image location is identified, based on the first image location corresponding to the particular second image location. This portion of the pixel data is then processed to generate the transformed image data. For example, where the first image location, which corresponds to the second image location, lies in between the input pixel locations, a portion of pixel data representing pixel values for a plurality of pixel locations representing input pixel locations surrounding the first image location may be used to generate transformed pixel data representing the output pixel location, which may be comprised by the transformed image data representing the transformed version of the portion of the image. In an example, a portion of transformed pixel data representing a particular second image location is to be generated. The second image location is mapped to a first image location 530. In this case, a portion of pixel data representing pixel values for input pixel locations 540a-540d may be used to generate the portion of transformed pixel data representing the second image location. In other examples, the block of pixels which is identified may be any suitable size, although typically, for bicubic interpolation, the block of input pixel locations is four by four pixels.

A portion of pixel data representing pixel values for input pixel locations of the block of input pixel locations is obtained, for example from the temporary storage 440. The portion of the pixel data may be for a subset of the input pixel locations of the block of input pixel locations rather than for each input pixel location. For example, the portion of the pixel data stored in the temporary storage 440 may include data representing pixel values of a subset of the pixels of the block of input pixel locations shown in FIG. 7, to reduce storage and processing requirements. For example, if an input frame includes 2 million input pixel locations (or pixels), a portion of pixel data representing 16000 input pixel locations of the 2 million input pixel locations may be streamed into the temporary storage 440.

Calculating at least one output pixel value for the second image location (which is for example an output pixel location) may include interpolating based on the portion of the pixel data. Using the portion of the pixel data, an interpolation can be performed to calculate a pixel value for the first image location 530. The pixel value for the first image location 530 is then associated with the second image location in the transformed version of the portion of the image (e.g. in the output frame).

As the skilled person will appreciate, various different interpolation techniques may be used to obtain the transformed pixel data for the second image location from a portion of the pixel data identified based on the first image location. For example, the interpolation may be a bicubic interpolation. The interpolation may use at least one polyphase filter, for example a bank of polyphase filters, which may depend on the first image location. For example, the coefficients of the at least one polyphase filter may differ depending on the first image location.

In some examples, there may be two first image locations that lie within the same block of input pixel locations. FIG. 7 shows such an example for the first image locations 530, 550. The interpolation process may be performed similarly for each of the first image locations, using the same portion of the pixel data, to avoid re-obtaining or re-reading the portion of the pixel data corresponding to the block of input pixel locations. Instead, the portion of the pixel data can be re-used for both first image locations 530, 550 and a similar process can be used to obtain the pixel values for each. For example, the same polyphase filters may be used for each, but with different coefficients (although, in other cases, different filters, e.g. different polyphase filters, may be used for each).

Typically, the derivation of coefficients for the interpolations implemented by the pixel interpolation module 430 of FIG. 6 may be performed prior to receiving the image data, for example using suitable software, as the geometric distortion for example depends on the lens associated with the image data, which may not change between receiving different sets of image data such as different frames of a video. For example, the coefficients may be obtained using test data and supplied to the apparatus as part of the configuration system. In other examples, though, the apparatus may be used to apply the at least one transformation to the image data and to derive the coefficients for use in the interpolations described above. For example, the transformation performed may be time-varying, for example in dependence on a time-varying change in position of a lens used to capture or display an image represented by the image data. For example, it may be possible to alter a pan, tilt or zoom of an image capture device comprising the lens, to capture a different scene. In such cases, it may be desirable to recalculate the coefficients of the interpolations using the apparatus 400.

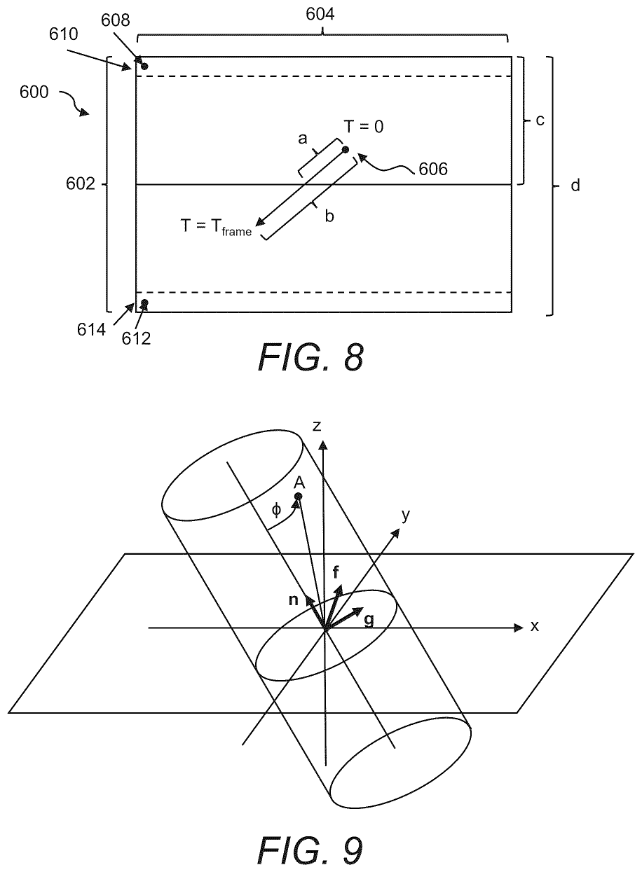

FIG. 8 illustrates an example of a time-varying transformation. In FIG. 8, the image data represents a frame 600 captured by an image capture device, such as a camera comprising an image sensor, for example a CMOS (complementary metal oxide semiconductor) sensor. The image capture device has a rolling shutter, and is operable to capture image data on a line-by-line basis, so as to obtain a frame 600 comprising an plurality of horizontal rows 602 and vertical columns 604. For example, if it takes 50 milliseconds to capture the frame 600, the first row of the frame 600 will be captured 50 milliseconds before the last row of the frame 600, during which time. If the image capture device moves during this 50 millisecond window of time, the field of the image may become distorted. For a frame 600 that includes geometric distortion, such as a frame 600 captured using a fisheye lens, global correction for movement of the image capture device during capture of the frame 600, e.g. using a global motion estimation representing an average motion of the image capture device during frame capture, may further distort the frame 600.

Instead, in the example of FIG. 8, line-by-line (e.g. row-by-row) adjustments are made to the transformation so as to compensate for motion of the image capture device during capture of the frame 600 using the rolling shutter. This is shown schematically in FIG. 8 as a motion of a first image location 606 at a first image surface (corresponding to the plane of the frame 600) from a point at a time T=0 to a different point within the first image surface at a time T=T_{frame}.

In FIG. 8, determining the mapping between the first and second image locations comprises compensating for the motion of the image capture device during the capture of the frame 600. The approach of FIG. 8 utilizes the fact that a vertical position of a given first image location at the first image surface (e.g. corresponding to a pixel location in a fisheye image) is related to the time at which the data for that first image location was captured. Based on the time difference between capturing image (e.g. pixel) data for different first image locations and the motion of the image capture device (which can be obtained using a suitable measurement device associated with the image capture device, such as a gyroscope of a smartphone (or other device) comprising the image capture device, which for example measures the orientation and/or velocity of the device over time), an adjustment to the mapping between first and second image locations can be performed to compensate for the motion of the image capture device. For example, motion data may be obtained, e.g. using the measurement device, which is indicative of the motion (which may be motion at the first image surface or the second image surface). As an example, a gyroscope may capture an angle and angular speed of the image capture device relative to an inertial reference frame. In this example, a position of a projection plane to which an image is to be projected (e.g. corresponding to the second image surface) may be relatively stable or slowly moving within this inertial reference plane, e.g. so that motion of the projection plane within the inertial reference plane can be ignored or compensated for straightforwardly. This allows projection plane basis vectors and an origin of the projection plane as a function of time to be obtained. Linear algebra can then be used to map between a coordinate system associated with the image capture device (e.g. corresponding to the first image surface) and a coordinate system associated with the projection plane.

The motion of the image capture device results in a geometric relationship between the first and second image surfaces that itself varies during capture of the frame 600 (where the first image surface for example corresponds to the sensor image plane and the second image surface for example corresponds to a projection plane, such as a display plane for displaying a version of the frame 600 that is transformed to reduce or otherwise adjust geometric distortion in the frame). The relative motion between the first and second image surfaces can be expressed as velocity vectors for respective second image locations at the second image surface, indicating the velocity of a given second image location with respect to the first image surface (although, conversely, the motion can be expressed as velocity vectors for first image locations at the first image surface).

Motion data indicative of the motion may be transformed between the first image surface and the second image surface to obtain transformed motion data. For a given second image location, a velocity vector (e.g. represented by the motion data) can be transformed to the first image surface in the same manner as transforming the second image location itself, for example using an analytical stereographic projection and then, in some cases, adjustment of the stereographic projection e.g. within the first image surface, using a derivative of the lens projection function evaluated at the projected image location within the first image surface (instead of the lens projection parameter described above) as a magnification factor.

The mapping between the first and second image surfaces can be determined using the transformed motion data. For example, multiplying the (transformed) velocity vector (which can be referred to as a motion vector) by a time taken to capture the frame 600 (which can be referred to as a frame scanning time) allows a line segment within the first image surface to be identified. In this case, the line segment corresponds to a trajectory of the point to be interpolated (e.g. the first image location 606 of FIG. 8). The start of the segment corresponds to the same time as a top line of the frame 600 and the end of the segment corresponds to the same time as the bottom line of the frame 600, with the sampling point (the first image location 606) being located within the segment. The relative position of the sampling point within the segment is the same as its vertical position within the frame. In FIG. 8, this is expressed as a/b=c/d, where a represents the distance between the first image location 606 at T=0 and the end of the segment, b represents the distance between the first image location 606 at T=0 and T=T_{frame}, c represents the vertical extent of the segment, and d represents the vertical extent of the frame 600.

If s,t is the projected image location (obtained by projecting a second image location at the second image surface to the first image surface corresponding to the frame 600 captured by the image capture device, shown as point A′ in FIGS. 3 to 5), and vₛ, vₜ are components of a transformed motion vector for the projected image location over the frame 600 (in other words, the velocity of the point s,t at the first image surface in the horizontal and vertical directions, respectively, which may be represented by transformed motion data), and the top and bottom rows of the frame 600 are at H/2 and −H/2 at the first image surface, then the compensated point s′,t′ can be found as:

$$t + β {v}_{t} = \frac{H}{2} - β H$$

$$β = \frac{\frac{H}{2} - t}{H + {v}_{t}}$$

$$\{ \begin{matrix}{s}^{′} = s + {v}_{s} \frac{\frac{H}{2} - t}{H + {v}_{t}} \\ {t}^{′} = t + {v}_{t} \frac{\frac{H}{2} - t}{H + {v}_{t}}\end{matrix}$$

In this case, the compensated point s′,t′ can be used to obtain compensated x′,y′ points representing the first image location corresponding to the second image location, after compensation for the motion of the image capture device, for example using a lens projection parameter as described above (or the compensated point s′,t′ can be taken as the first image location after motion compensation if the lens is a stereographic lens and h( ) is equal to 1). The direct reprojection (i.e. transformation) of the motion vector at the second image surface to the transformed motion vector vₛ, vₜ at the first image surface can be done analytically, but the equations become complex; in practice doing two reprojections (i.e. two transformations, which each transformation individually performed as described above with reference to FIGS. 2 to 5), for example, for start and end rows of the frame 600, may be computationally similar or easier. In this case, the velocity for a given pixel in the projection plane (e.g. corresponding to the second image surface) can be calculated as the distance between these two projections of the pixel at a sensor image plane (e.g. corresponding to the first image surface), using these two sets of projection parameters, divided by the time between them.

For example, the transformation from a point A at a second image surface (corresponding to a display surface) to the first image surface corresponding to the frame 600 as described with reference to FIGS. 2 to 5 can be expressed as:

$$( x , y ) = P ( u , v ; \vec{n} , l , \vec{f} )$$

where (u, v) represents the coordinates of the point to be transformed (point A) at the second image surface (which as a flat plane in this example), (x, y) represents the transformed coordinates at the first image surface after analytical stereographic projection to the first image surface and adjustment of the stereographic projection within the first image surface (e.g. corresponding to point A″ of FIG. 3b), and {\vec{n}, l, \vec{f}} are parameters defining the second image surface (the third parameter, \vec{g}, can be derived as a vector product of \vec{n}, \vec{f}). {\vec{n}, l, \vec{f}} indicate the geometric relationship between the first and second image surfaces.

If there is motion between the first and second image surfaces (e.g. due to motion of the image capture device), the so-called rolling shutter effect means that different lines of the frame 600 are captured at different times. As the projection parameters typically change over time, different projection parameters may be applied to different output pixels of a transformed version of the frame 600. In other words, the time at which a given output pixel was captured can be used to estimate the position of that output pixel (as the projection parameters change with time). However, the capture time of an input pixel (which is mapped to the given output pixel) is itself a function of a vertical position of the input pixel within the frame 600, which is a function of time.

The position of a given output pixel can be determined exactly (as discussed further below) or can be approximated. For example, the expression {\vec{n}₀, l₀, \vec{f}₀} can be used to define a first geometric relationship between the first and second image surfaces at a first time, e.g. at the moment of capturing the top row of the frame 600 (which can be referred to as the top image scan line), and the expression {\vec{n}₁, l₁, \vec{f}₁} can be used to define a second geometric relationship between the first and second image surfaces at a second time, e.g. at the moment of capturing the bottom row of the frame 600 (which can be referred to as the bottom scan line, with a vertical coordinate H). The following values can be calculated, e.g. by running two projection engines (which may be performed simultaneously):

$$\{ \begin{matrix}( {x}_{0} , {y}_{0} ) = P ( u , v ; {\vec{n}}_{0} , {l}_{0} , {\vec{f}}_{0} ) \\ ( {x}_{1} , {y}_{1} ) = P ( u , v ; {\vec{n}}_{1} , {l}_{1} , {\vec{f}}_{1} )\end{matrix}$$

In this way, a first mapping between a first row image location 608 (e.g. a first pixel location, expressed as (x₀, y₀)) of a first row 610 of the frame 600 and a second image location at the second image surface (expressed as (u, v)) can be obtained. Similarly, a second mapping between a second row image location 612 (e.g. a second pixel location, expressed as (x₁, y₁)) of a second row 614 of the frame 600 and the second image location (expressed as (u, v)) can also be obtained. In this example, the first row 610 is captured at a first time (and, in this case, is the starting row of the frame 600) and the second row 614 is captured at a second time (and, in this case, is the final row of the frame 600). The first and second mappings can be obtained separately, e.g. as described with reference to FIGS. 2 to 5. The mapping between the second image location, u, v, and the first image location 606, x,y, can be obtained based on the first and second mappings, e.g. using a first-order approximation. For example, if the first row 610 is the starting row of the frame 600, then the (x₀, y₀) position is the correct solution. Similarly, the (x₁, y₁) position is the correct solution provided the second row 614 is the final row of the frame 600. However, for other rows, at other y positions, the correct position will be somewhere between the (x₀, y₀) and (x₁, y₁) positions. A linear interpolation can for example be used to estimate this position from the (x₀, y₀) and (x₁, y₁) values. For example, the first image location 606 can be obtained using a linear interpolation as:

$$\{ \begin{matrix}β \approx \frac{{y}_{0} + {y}_{1}}{2 H} \\ x = {x}_{0} + β ( {x}_{1} - {x}_{0 )} \\ y = {y}_{0} + β ( {y}_{1} - {y}_{0 )}\end{matrix}$$

The exact formula is

$$β = \frac{{y}_{0}}{H + {y}_{0} - {y}_{1}} ,$$

but it involves a more complex calculation comprising a division instead of a multiplication by a constant

$$( \frac{1}{2 H} ) ,$$

which may be a less efficient use of computational resources given that the approach of interpolation between two transforms is an approximation itself. It is to be appreciated that this approach does not depend on the transformation expressed as P( ) being a fisheye correction: it can be applied to other transformations as well, for example, affine transform, rotation, perspective correction etc.

The first image location 606 can be obtained from using the first and second mappings using a 2-point linear approximation as described above. However, other approaches are possible. For example, at least one further mapping between the second image location and a respective first image location in an other row of the frame 600, captured at an other point in time than the first and second times, can also be obtained, and the first image location 606 can be obtained based on the calculated mappings using e.g. a piecewise linear approximation of (x, y)=P(u, v; \vec{n}, l, \vec{f}) or a higher order approximation. The first row and the second row need not be the top and bottom rows of the frame 600. For example, the first row and the second row may be the rows located at e.g. 20% and 80% of a height of the frame 600. This may improve accuracy if the frame 600 comprises a circularly distorted image, in which the top and bottom rows represent relatively smaller areas of the (undistorted) image compared to rows that are more centrally located. In particular, this may improve the linear interpolation or extrapolation accuracy because more image pixels are projected with parameters close to interpolation reference points. It is to be appreciated that the positions of the first and second rows within the frame may be optimized, e.g. offline, to reduce the interpolation error across the frame 600, for example relative to the exact solution.

The exact solution is:

$$\{ \begin{matrix}τ = \frac{T}{H} y \\ ( x , y ) = P ( u , v ; \vec{n} ( τ + {t}_{0} ) , l ( τ + {t}_{0} ) , \vec{f} ( τ + {t}_{0} ) ) )\end{matrix}$$

where T is the time to capture the image (e.g. the frame 600), H is the image height and t₀ is the moment of capturing the top row of the image. It can be solved by numerical methods, for example, by iterations:

$${τ}_{i + 1} = \frac{T}{H} {P}_{y} ( u , v ; \vec{n} ( {τ}_{i} + {t}_{0} ) , l ( {τ}_{i} + {t}_{0} ) , \vec{f} ( {τ}_{i} + {t}_{0} ) ) )$$

However, this is merely an example, and it is to be appreciated that other numerical methods may instead be used to obtain an exact solution.

However, the two-point linear approximation described above may be sufficiently accurate, as the correction itself due to the motion of the image capture device is typically small and the extra complexity of more precise approaches may not be warranted by the relatively small increase in image quality achievable by these methods. Indeed, if the motion of the image capture device is more profound, the frame 600 may be smeared, which may require other correction methods not discussed here.

In examples above, the first and second image surfaces are both substantially flat surfaces (such as flat within acceptable tolerances). However, in other examples, at least one of the first image surface or the second image surface is a non-flat surface. For example, at least one of the first image surface or the second image surface may comprise a cylindrical surface and/or a curved surface. This allows an image obtained in a flat image plane (e.g. corresponding to the first image surface) to be projected to a non-flat (e.g. curved) second image surface. This may be used to obtain a panoramic image, such as a 180 or 360 degree panoramic image. For example, if a camera is mounted horizontally (e.g. a room wall or vehicle reversing camera), a 180 degree panoramic image can be obtained by projecting an image captured by the camera onto an imaginary cylinder and then flattening the projected image to obtain a flat image. In another approach, a horizontally mounted camera (e.g. a ceiling camera) can be used to capture an image, and the captured image can be projected on a vertical cylinder and then flattened to obtain a flat, 360 degree panoramic image. In other cases, a non-flat (e.g. curved or cylindrical) projection may be calculated in reverse to pre-distort an image for display on a non-flat (e.g. curved or cylindrical) display device, although typically a curvature of such display devices tends to be relatively small, and the amount of distortion tends to be viewer-dependent.

In general, it is to be appreciated that use of a stereographic intermediate representation as described in examples herein allows images obtained with a camera with a field of view of more than 180 degrees to be projected. For example, if a camera has a convex lens, the field of view may be greater than 180 degrees, such as 190 degrees. With the approaches described herein, a field of view of 180 degrees is not a singularity point (unless the camera projection itself has a singularity at 180 degrees), meaning that the approaches herein are more robust than those approaches that do suffer from such singularity points at a field of view of 180 degrees.

FIG. 9 illustrates an example in which a mapping in accordance with examples herein is used to project at least a portion of an image (associated with a first image surface) onto a surface of a cylinder (associated with a second image surface). The cylinder has a unit radius and a longitudinal axis passing through an origin of a 3D Cartesian coordinate system (labelled x, y, z in FIG. 9). In FIG. 9, n is the vector along the longitudinal axis of the cylinder and f, g complete the orthonormal basis. For each point A on the cylinder with coordinates (u, y) (corresponding to a second image location) the 3D coordinates will be:

$$\vec{A} = u \vec{n} + \vec{f} cos φ + \vec{g} sin φ$$

$$‖ \vec{A} ‖ = \sqrt{1 + {u}^{2}}$$

The mapping from this second image surface to a first image location at the first image surface (which in this example is a flat surface defined by the x, y, z coordinates) can be performed in a similar way to other examples described herein, but using the expressions for \vec{A} and ∥\vec{A}∥ for a point A on the cylinder, given above.

If an output image (e.g. corresponding to a transformed version of an input image) is scanned in the direction of φ, then sin( ) and cos( ) can be pre-calculated as tables for a given step size Δφ. If there is sufficient storage in a data processing apparatus for performing this process, the term \vec{f} cos φ+\vec{g} sin φ can be tabulated for each output column before performing the mapping. However, another possibility is to tabulate this term sparsely and interpolate between tabulation points. The norm ∥\vec{A}∥ will be the same along the scan line.

Assuming that sin( ) and cos( ) are tabulated, and scanning along the e direction, calculating sin( ) and cos( ) will involve 2 look-ups, and calculating \vec{A} will involve 6 multiplication operations and 6 addition operations. Furthermore, the value \vec{A}+\vec{Z}∥A∥ that is to be calculated differs from \vec{A} only by a constant shift in the Z component. Calculating s,t (the analytical stereographic projection of \vec{A} to the first image surface, e.g. to obtain a projected image location, representable as a point A′) involves 2 division operations. If performed, converting s,t to x,y at the first image surface (e.g. by adjusting the projected image location at the first image surface to obtain the first image location, representable as a point A″) involves 4 multiplication operations, 1 addition operation, and 1 LUT operation. This amounts to a total number of operations per mapping of a particular image location of: 10 multiplication operations, 7 addition operations, 2 LUT operations to obtain the sin( ) and cos( ) values, and 1 LUT to obtain the lens projection parameter (e.g. the value of h( ) for a particular s,t).

The above examples are to be understood as illustrative examples. Further examples are envisaged. In particular, the transformations discussed above can be performed on a per-pixel (e.g. per-image-location) basis. There may be a trade-off between computational cost and image quality if it is assumed that the transformations are smooth. For example, the transformations may be calculated on a sparse grid (e.g. every 2 or 4 samples, such as every 2 or 4 second image locations (e.g. pixel locations)) and then performing an interpolation between these points.

The specific examples of FIGS. 3 to 5, 8 and 9 relate to transforming a second image location at a second image surface (e.g. corresponding to a pixel location of a transformed version of an image) to a first image location at a first image surface (e.g. corresponding to a location within the image to be transformed, which may or may not coincide with a pixel location). In other examples, though, the mapping is from the first image surface to the second image surface. The description above applies correspondingly to these other examples. For example, the same approach discussed with reference to these examples of FIGS. 3 to 5, 8 and 9 can be performed in a reverse order using a comparable number of operations, e.g. to perform a display remapping for a display device such as an AR, MR or VR device.

An example of a reverse mapping will now be explained with reference to FIG. 4a. In the above description of FIG. 4a, a mapping from point A to point A′ is described. However, a mapping from point A′ to point A in the context of FIG. 4a will now be explained. It can be assumed that:

$$‖ \vec{a} ‖ = 1 ,$$

$$\vec{{A}^{′}} \cdot \vec{Z} = 0$$

$$‖ \vec{{A}^{′}} ‖ = r = \sqrt{{s}^{2} + {t}^{2}}$$

The second image location, \vec{A}, at the second image surface is to be transformed to which the first image location, \vec{A}′, at the first image surface. The first image location, \vec{A}′, can be defined as:

$$\vec{{A}^{′}} = γ ( \vec{a} + \vec{Z} ) - \vec{Z}$$

$$\vec{{A}^{′}} \cdot \vec{Z} = 0$$

Reordering, squaring both sides and separating β can be used to obtain:

$$β \vec{a} = \vec{{A}^{′}} + ( 1 - γ ) \vec{Z}$$

$${γ}^{2} = {‖ \vec{{A}^{′}} ‖}^{2} + {( 1 - γ )}^{2}$$

$$γ = \frac{{r}^{2} + 1}{2}$$

Defining a vector \vec{D} (collinear to \vec{α}) as:

$$\vec{D} = ( \begin{matrix}\begin{matrix}2 s \\ 2 t\end{matrix} \\ 1 - {r}^{2}\end{matrix} )$$

$$\vec{a} = \frac{1}{1 + {r}^{2}} \vec{D}$$

Transforming to the second image location \vec{A} at the second image surface, the vectors \vec{A}, \vec{α} and \vec{D} are collinear, i.e. \vec{A}∝\vec{α}∝\vec{D}. Using the plane equation of \vec{A}·\vec{n}=l, a scale factor for \vec{D} can be found as:

$$( γ \vec{D} ) \cdot \vec{n} = l$$

$$γ = \frac{l}{2 s {n}_{1} + 2 t {n}_{2} + {n}_{3} ( 1 - {r}^{2} )}$$

From this, the components of \vec{A} can be found as:

$$\{ \begin{matrix}\begin{matrix}{A}_{1} = 2 γ s \\ {A}_{2} = 2 γ t\end{matrix} \\ {A}_{3} = γ ( 1 - {r}^{2} )\end{matrix}$$

where r²=s²+t². From this, the (u, v) coordinates of the second image location at the second image surface can be found as:

$$\{ \begin{matrix}u = \vec{f} \cdot \vec{A} = γ \cdot ( 2 {sf}_{1} + 2 {tf}_{2} + ( 1 - {r}^{2} ) {f}_{3} ) \\ v = \vec{g} \cdot \vec{A} = γ \cdot ( 2 {sg}_{1} + 2 {tg}_{2} + ( 1 - {r}^{2} ) {g}_{3} )\end{matrix}$$

If the adjustment of the projected image location obtained by an analytical stereographic projection (s, t) based on a lens projection parameter to obtain a first image location (e.g. corresponding to lens coordinates) (x, y) is:

$$\{ \begin{matrix}x = s \cdot h ( {s}^{2} + {t}^{2} ) \\ y = t \cdot h ( {s}^{2} + {t}^{2} )\end{matrix}$$

The reverse adjustment can be expressed similarly:

$$\{ \begin{matrix}s = x \cdot \tilde{h} ( {x}^{2} + {y}^{2} ) \\ t = y \cdot \tilde{h} ( {x}^{2} + {y}^{2} ) \\ {r}^{2} = ( {x}^{2} + {y}^{2} ) {\tilde{h}}^{2} ( {x}^{2} + {y}^{2} )\end{matrix}$$

where the reverse scale function can be expressed as:

$$\tilde{h} ( z ) = \frac{1}{h ( {f}^{- 1} ( z ) )}$$

where f⁻¹(z) is a reverse function of:

$$f ( u ) = u \cdot {( h ( u ) )}^{2}$$

The reverse scale function is also an example of a lens projection function, in this case representing a reverse projection compared to that of the lens projection function h( ), and from which a lens projection parameter can be obtained).

The reverse scale function for various transformations are shown in the table below.

| Projection | f(Θ) | h(x) | \tilde{h}(x) |
|---|---|---|---|
| Stereographic | $tan \frac{θ}{2}$ | 1 | 1 |
| Gnomonic (perspective) | tan θ | $\frac{1}{1 - x}$ | $\frac{\sqrt{1 + 4 x} - 1}{2 x}$ |
| Equidistant | θ | $\frac{2 arctan \sqrt{x}}{\sqrt{x}}$ | $\frac{tan \frac{\sqrt{x}}{2}}{\sqrt{x}}$ |
| Orthographic | sin θ | $\frac{2}{1 + x}$ | $\frac{1 - \sqrt{1 - x}}{x}$ |
| Equisolid | $2 sin \frac{θ}{2}$ | $\frac{2}{\sqrt{1 + x}}$ | $\frac{1}{\sqrt{4 - x}}$ |

These reverse scale functions are not singular and can be calculated using fixed point arithmetic as they have well behaved limits and derivatives at x=0. Direct implementation of the reverse mapping involves 18 multiplication operations, 8 addition operations, 1 division operation and 1 LUT operation.

If the lens associated with the image to be displayed (in this case, the image transformed to the first image surface) is a stereographic lens, then further optimisations for incremental calculations are possible, such as an accumulator-based calculation of s², r² and denominator of β. For non-stereographic lenses, (s, t) may be recalculated for each image location transformed. In this case, a saving of computational power can be achieved by incrementally calculating x², trading 1 multiplication operation for 1 extra addition operation.

The approaches herein have a relatively low projection change overhead, which allows for an efficient implementation of time warp e.g. to compensate for high frequency tracking of movement of a head of the user of the device. For example, approaches herein can be used to adjust the projection plane (e.g. corresponding to the first or second image surface) on a row-by-row basis. This is further described with reference to FIG. 8, in which the geometric relationship between the first and second image surfaces varies over time due to motion of an image capture device capturing the frame 600. A time-varying geometric relationship may also be present in approaches herein in which a mapping is performed for reverse mapping (which may be referred to as a reverse reprojection) e.g. for an AR, MR or VR use-case.

It is to be understood that any feature described in relation to any one example may be used alone, or in combination with other features described, and may also be used in combination with one or more features of any other of the examples, or any combination of any other of the examples. Furthermore, equivalents and modifications not described above may also be employed within the scope of the accompanying claims.

1. A method comprising:
determining a mapping between a first image location at a first image surface, associated with a portion of an image, and a second image location at a second image surface, associated with a transformed version of the portion of the image, the determining the mapping comprising applying an analytical stereographic projection based on a geometric relationship between the first image surface and the second image surface;
obtaining image data representing the portion of the image, the image data comprising pixel data for a plurality of pixel locations within the portion of the image;
based on the first image location, identifying a portion of the pixel data for use in generating transformed pixel data for the second image location; and
processing the image data to generate transformed image data representing the transformed version of the portion of the image, the processing the image data comprising processing the portion of the pixel data to generate the transformed pixel data for the second image location.

2. The method of claim 1, wherein the applying the analytical stereographic projection generates a projected image location, and the determining the mapping comprises adjusting the projected image location based on a lens projection parameter of a lens associated with the image data.

3. The method of claim 2, wherein the lens is a non-stereographic, substantially axially-symmetric lens.

4. The method of claim 2, wherein the analytical stereographic projection is along an optical axis of the lens.

5. The method of claim 2, wherein the optical axis is substantially perpendicular to the first image surface or the second image surface.

6. The method of claim 2, wherein the lens is at least one of:
(i) a lens of an image capture device used to capture the image data, a lens of a virtual reality display device, a lens of an augmented reality display device, or a lens of a mixed reality display device;
(ii) a fisheye lens; or
(iii) a wide-angle lens.

7. The method of claim 2, wherein:
the projected image location is at the first image surface, and the adjusting the projected image location comprises adjusting the projected image location within the first image surface; or
the projected image location is at the second image surface, and the adjusting the projected image location comprises adjusting the projected image location within the second image surface.

8. The method of claim 1, wherein the processing the image data to generate the transformed image data adjusts geometric distortion such that a first geometric distortion of the image differs from a second geometric distortion of the transformed version of the image.

9. The method of claim 1, wherein at least one of the first image surface or the second image surface is a non-flat surface, optionally wherein the at least one of the first image surface or the second image surface comprises a cylindrical surface and/or a curved surface.

10. The method of claim 1, wherein the method comprises determining a further mapping between a third image location at the first image surface and a fourth image location at the second image surface, using difference data indicative of: a difference between the first image location and the third image location, at the first image surface, or a difference between the second image location and the fourth image location, at the second image surface,
and the method comprises identifying, based on the third image location, a further portion of the pixel data for use in generating further transformed pixel data, and the processing the image data comprises processing the further portion of the pixel data to generate the further transformed pixel data for the fourth image location.

11. The method of claim 10, wherein:
the difference data is indicative of the difference between the first image location and the third image location, at the first image surface, and the image data comprises a plurality of rows of image locations, at the first image surface, a row of the plurality of rows comprising the first image location and the third image location; or
the difference data is indicative of the difference between the second image location and the fourth image location, at the second image surface, and the transformed image data comprises a plurality of transformed rows of transformed image locations, at the second image surface, a transformed row comprising the second image location and the fourth image location.

12. The method of claim 1, wherein the applying the analytical stereographic project uses fixed-point arithmetic.

13. The method of claim 1, wherein:
the analytical stereographic projection is applied to the second image location, and a second normal at a second origin of the second image surface intersects the first image surface at a first position displaced from a first origin of the first image surface, and the applying the analytical stereographic projection uses first displacement data indicative of a first displacement of the first position from the first origin; or
the analytical stereographic projection is applied to the first image location, and a first normal at the first origin intersects the second image surface at a second position displaced from the second origin, and the applying the analytical stereographic projection uses second displacement data indicative of a second displacement of the second position from the second origin.

14. The method of claim 1, wherein the image data represents a portion of a frame of a video captured using an image capture device, and the determining the mapping comprises compensating for motion of the image capture device during capture of the frame.

15. The method of claim 14, comprising:
determining a first mapping between a first row image location of a first row of the frame and the second image location, the first row of the frame captured at a first time at which there is a first geometric relationship between the first image surface and the second image surface;
determining a second mapping between a second row image location of a second row of the frame and the second image location, the second row of the frame captured at a second time at which there is a second geometric relationship between the first image surface and the second image surface,
wherein the determining the mapping between the first image location and the second image location is based on the first mapping and the second mapping.

16. The method of claim 15, wherein the compensating for the motion comprises:
obtaining motion data indicative of the motion, at one of the first image surface or the second image surface; and
transforming the motion data between the first image surface and the second image surface to obtain transformed motion data,
wherein determining the mapping uses the transformed motion data.

17. Image processing apparatus comprising:
storage for storing image data representing a portion of an image, the image data comprising pixel data for a plurality of pixel locations within the portion of the image; and
at least one processor configured to:
determine a mapping between a first image location at a first image surface, associated with a portion of an image, and a second image location at a second image surface, associated with a transformed version of the portion of the image, wherein, to determine the mapping comprises applying an analytical stereographic projection based on a geometric relationship between the first image surface and the second image surface;
based on the first image location, identify a portion of the pixel data for use in generating transformed pixel data for the second image location;
obtain at least the portion of the pixel data from the storage; and
process the image data to generate transformed image data representing the transformed version of the portion of the image, wherein to process the image data comprising processing the portion of the pixel data to generate the transformed pixel data for the second image location.

18. The image processing apparatus of claim 17, wherein the applying the analytical stereographic projection generates a projected image location, and the determining the mapping comprises adjusting the projected image location based on a lens projection parameter of a lens associated with the image data.

19. A device comprising the image processing apparatus of claim 17 and the lens.

20. The device of claim 19, wherein the device is an image capture device for capturing the image data, a virtual reality display device, an augmented reality display device or mixed reality display device.
